(19) United States
(12) Patent Application Publication
(10) Pub. No.: US 2018/0348169 A1
(43) Pub. Date: Dec. 6, 2018

(54) System and Method for Assessment of Irregularity in a Wooden Material Surrounded by a Substrate

(71) Applicants: Peter Lee, Auckland (NZ); Wayne Hall, Auckland (NZ)

(72) Inventors: Peter Lee, Auckland (NZ); Wayne Hall, Auckland (NZ)

(21) Appl. No.: 15/773,032

(22) PCT Filed: Nov. 4, 2016
(86) PCT No.: PCT/IB2016/056633

§ 371 Date: May 2, 2018

(30) Foreign Application Priority Data
Nov. 6, 2015 (NZ) 713995

(51) Int. Cl. G01N 29/11; G01N 29/04; G01N 29/06; G01N 29/26; G01N 29/28; G01N 29/48

(52) U.S. Cl. CPC G01N 29/11; G01N 29/043; G01N 29/0645; G01N 29/0672; G01N 2291/106; G01N 29/28; G01N 29/48; G01N 2291/0238; G01N 2291/102; G01N 29/262

(57) ABSTRACT

A system for assessment of irregularity in wooden material below the surface of a substrate, from above the surface of the substrate. The wooden material extending from below to above the surface of the substrate and surrounded by the substrate below the surface of the substrate. The system comprising at least one transmitter and receiver or transducer arranged to transmit energy through the material from above the surface of the substrate towards the part of the material below the surface, and to receive energy reflected from the material back through the surface, and a processor arranged to analyse the reflected energy and provide an indication of irregularity in the material below the surface of the substrate.

### FIELD OF INVENTION

The invention comprises a system and method for assessment of irregularity in a material surrounded by a substrate, from above a surface of the substrate, such as rot or decay in the in-ground part of wooden poles or other wooden elements buried below the ground surface.

### BACKGROUND

Traditionally poles are tested using a sounding hammer and trained ear or microphone. Recently instruments have been developed to measure the speed of ultrasonic transmission across the pole or the resistance to drilling a hole. These tests are generally restricted to measuring in the cross-section of the pole above ground. Measurements based upon measuring the resistance to drilling a hole can be used to penetrate short distances below ground but are inherently destructive and are limited to detecting changes in resistance along the drill path. The ultrasonic tester is inherently non-destructive.

The best available technology today for detecting the physical condition of wooden structures below ground is to measure the resistance to drilling by a small diameter drill bit as it penetrates progressively into the structure using an instrument called a Resistograph. The drill bit has a length of up to approximately 45 cm and by drilling a hole at an angle downward from ground level it is possible to detect variations in resistance of up to approximately 30 cm below ground. A reduction in resistance to drilling indicates a region of weakness in the structure. However, this technique is inadequate to detect discontinuities more than 30 cm below ground or away from the drill path. The effective detection of defects below ground requires excavation. Many poles are set in concrete or asphalt and are not amenable to such examination. Drilling also inherently damages and weakens the structure being tested, and excavation can further weaken the foundation of the pole.

Currently used in the testing for above ground defects is the measurement of ultrasonic velocity between a source and receiver mounted on the surface of the pole, such that the path of the ultrasonic energy from source to receiver intersects the region of interest. By analysing the result of several such scans across the same cross-section it is possible to deduce a two-dimensional view of variations in density in that cross-section. This enables the remaining good wood to be visualised should the pole have been subjected to internal rot or insect infestation.

There is an unsolved problem of non-destructively detecting defects in wooden structures below the ground, where most decay occurs.

Ground penetrating radar has been used to detect rot in trees above ground and map the roots of trees below ground. However, it is the experience of the inventors that this technique when applied to wooden poles to inspect below ground defects provides only gross estimates of internal damage with little or no value in terms of estimating the fitness for use. When angled to the pole at ground level, ground penetrating radar has limited ability to effectively examine for defects beyond depths of approximately 30 cm. This is inadequate to reliably assess defects which are below this depth and which can adversely affect the load bearing capacity of the pole.

### SUMMARY OF INVENTION

In broad terms the invention comprises in a first aspect a system for assessment of irregularity in material below a surface of a substrate, from above the surface of the substrate, the material being part of a body of the material surrounded by the substrate below the surface of the substrate, the body extending from below to above the surface of the substrate, and the assessment system being adapted to be positioned above the surface of the substrate, the system comprising:
at least one transmitter and receiver or transducer arranged to transmit energy through the body from above the surface of the substrate towards the material of the body below the surface, and receive energy reflected from the material back through the surface, and
a processor arranged to analyse the reflected energy and provide an indication of irregularity in the material below the surface of the substrate.

In at least some embodiments the transmitter(s) or transducer(s) are arranged to transmit the transmitted energy in a focused beam shape and/or direction through the material of the body. The at least one transmitter and receiver or transducer may comprise an array of multiple transmitters and a receiver or receivers, or an array of multiple transducers, and may comprise an array of two or more arrays of multiple transmitters or multiple transducers. At least one array may be a phased array. The phased array may be a fixed phased array or a dynamically phased array enabling steering of the transmitted energy through the material of the body below the surface by varying the phase relationships.

In broad terms the invention comprises in a second aspect a method for assessment of irregularity in material below a surface of a substrate from above the surface of the substrate, the material being part of a body of the material surrounded by the substrate below the surface of the substrate and the body extending from below to above the surface of the substrate, the method comprising:
directing energy from a transmitter or transducer, through the body from above the surface of the substrate, towards the material of the body below the surface, receiving energy reflected from the material back through the body, and
analysing and/or displaying the reflected energy to determine an indication of irregularity in the material below the surface of the substrate.

The substrate may be ground, and the material wood below the ground surface, of a wooden element such as a wooden pole extending from below the ground surface to above the ground surface. The ground surface may be covered by asphalt or concrete for example. The system may be for assessment for any rot, decay, insect infestation or damage, holes, or delamination in the wooden element below the ground. Alternatively, the substrate may be for example concrete. Alternatively again, the wooden element may be a pile in the sea floor (the substrate/ground comprises the seabed), supporting a wharf for example. Further alternatively, the wooden element may be a beam (a non-vertical element) an end of which is encased in a concrete column or simply inaccessible due to obstructions, and in this specification ‘above’ and ‘below’ the surface should be understood relatively.

In at least some embodiments the method or system includes calibrating the system by transmitting and receiving through the body above the surface of the substrate.

In at least some embodiments the system comprises a mount or mounts adapted to position the transmitter(s) and receiver(s) or transducer(s) adjacent the body above the surface of the substrate and at an angle to an axis of the body extending from below to above the substrate. The mount or mounts may be adapted to position the transmitter and receiver or transducer at an angle in the range above 0 to below 180 degrees to the surface of the substrate, such as for example at an angle in the range 30 to 60 degrees. The mount or mounts may be adapted to enable adjustably positioning the transmitter and/or receiver or transducer at multiple different angles. In at least some embodiments the mount or mounts are adapted to enable adjustably positioning the transmitter and/or receiver or transducer at multiple different vertical spacings above the surface of the substrate. In at least some embodiments the system comprises a mount or mounts adapted to position the transmitter(s) and receiver(s) or transducer(s) at locations spaced around an axis of the body extending from below to above the substrate, such as locations spaced substantially equidistantly around said axis of the body. In at least some embodiments the system may be arranged to assess irregularity in the material below the surface of the substrate to an extent or depth of at least 4 metres below the surface of the substrate.

In at least some embodiments the transmitter and receiver or transducer operate at a frequency or frequencies above about 200 Hz or above about 2 kHz or above about 5 kHz or above about 10 kHz or above about 20 kHz and/or at a frequency or frequencies below about 500 kHz or below about 300 kHz or below about 100 kHz or below about 20 kHz and/or at other sonic or ultrasonic frequency or frequencies. In at least some embodiments the system comprises the transmitter(s) or transducer(s) is/are arranged to transmit energy as a pulse or series of pulses. In at least some embodiments the transmitter(s) or transducer(s) has a Q factor of not more than about 4.

In this specification:
‘ground’ includes earth and any man-made ground surface such as concrete or asphalt.
‘transducer’ includes both a combined transmitter and receiver and separate transmitter and receiver, unless the context otherwise indicates.
‘and/or’ means ‘and’ or ‘or’, or both.
‘phased array’ means an array of two or more transmitters or transducers or transmitter or transducer elements driven with signals with different relative phases or timing to focus the transmitted energy in a desired beam shape or direction.
‘(s)’ following a noun means the plural and/or singular forms of the noun.
‘comprising’ means “consisting at least in part of”. When interpreting statements in this specification which include that term, the features, prefaced by that term in each statement, all need to be present but other features can also be present. Related terms such as “comprise” and “comprised” are to be interpreted in the same manner.

### BRIEF DESCRIPTION OF THE FIGURES

The invention is further described with reference to the accompanying figures and by way of example, in which:

FIG. 1 schematically shows a cross-section of part of a pole with a phased array transducer above the ground, the buried pole end, with a phased array beam scanning part of the pole below the ground,

FIGS. 2A and 2B schematically show two cross-sections of a pole; FIG. 2B shows part of the pole with a phased array transducer above the ground, and the buried pole end, and FIG. 2A shows an enlarged view of part of the same pole and the phased array transducer, and

FIG. 3 is similar to FIG. 1 but schematically shows a cross-section of a pole and a phased array transducer scanning part of the pole above the ground.

### DETAILED DESCRIPTION OF EMBODIMENTS

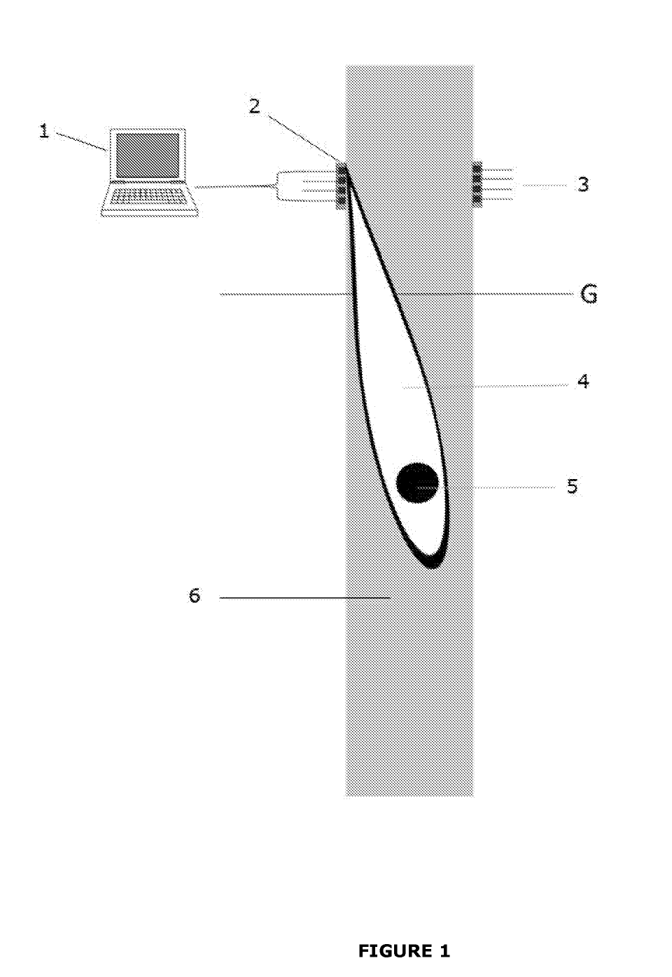

As stated the invention comprises a system and method for assessment of irregularity in a material surrounded by a substrate and on one side of a surface of the substrate, from another side of a surface of the substrate. FIG. 1 shows an embodiment of a system of the invention for assessing rot or decay, or other adverse factors such as insect infestation or damage, or holes, in wood buried in the ground i.e. below the ground surface, of a wooden element such as a pole or pile. Where the wooden element is a laminated wooden element the system may be effective for assessing for delamination.

As stated in at least some embodiments the transmitter(s) or transducer(s) are arranged to transmit the transmitted energy in a focused beam shape and/or direction through the material of the body. The at least one transmitter and receiver or transducer may be a single transmitter and receiver or transducer or may comprise an array of multiple transmitters and a receiver or receivers, or an array of multiple transducers, and may comprise an array of two or more arrays of multiple transmitters or multiple transducers. At least one array may be a phased array. The phased array may be a fixed phased array or a dynamically phased array enabling steering of the transmitted energy through the material of the body below the surface by varying the phase relationships. In the embodiment shown in FIG. 1 the system comprises two phased arrays of ultrasonic transducers, as indicated at 2 and 3 in the figures, which are positioned or mounted to direct energy through the pole 6 towards the below ground part of the pole, and to receive energy reflected back through the pole in order to assess for irregularity in the pole.

The transducers may operate at a single frequency or a range of frequencies in the range above about 200 Hz or above about 2 kHz or above about 5 kHz or above about 10 kHz or above about 20 kHz and/or below about 500 kHz or below about 100 kHz or below about 100 kHz or below about 20 kHz and/or at other sonic or ultrasonic frequency or frequencies for example. The frequency is e.g. a relatively low frequency so that the ultrasonic energy will penetrate into the pole for example up to four metres below ground, and preferably detect defects with dimensions on the order of a centimetre or more. The transducers may operate over a wide bandwidth so that the pole can be tested over a broad band of frequencies with a single pulse. The transmitter(s) or transducer(s) may have a Q factor of not more than about 4.

The transducers may emit a short pulse of energy which is of a shorter length than the time required for the pulse to return to the transducer after being reflected in the pole, or series of such pulses, such as of duration less than about 250 milliseconds or less than about 100 milliseconds or less than about 50 milliseconds or less than about 2 or 1 millisecond(s) for example. This gives lower reverberations and ensures that the transducer is receiving as much of an uninterrupted signal as possible and is not picking up unwanted reflections or signals. Alternatively, the transducers may emit a longer or in some embodiments a continuous pulse into the pole. Preferably, the short pulse of energy comprises a chirp of multiple different frequencies to facilitate differentiation of true reflections from reverberations. The preferred pitch (i.e. the distance between adjacent transducers in a phased array) of the transducers is a function of the central frequency.

There are different waveforms of interest, each of which can interact with defects in a different way. These waveforms of interest can include compression and shear waves. Characteristics of interest in the reflected signals may be the time of flight and intensity of the reflected beams which may be interpreted in terms of the extent, position and nature of any discrepancy in the density of the pole in the path of the beam. Transducers may be arranged to direct two or more beams, as indicated by 4 in the Figures, at different angles, and/or may be positioned at different diametric and/or vertical positions to map the discrepancy in three dimensions for more precise information. The amount of power supplied to the transducers may be varied so that signal returns can be algorithmically compared. Variations in the form of reflected energy may be interpreted in terms of the type and distance of defects from the probe. Information from multiple scans may be integrated into 2D or 3D representations of the below ground structure of the pole (e.g. tomographic views). Animations of representations of the pulse echoes may also be used to display the results of the scan reflections.

The transducers are preferably designed to be heavily damped by providing absorptive backing and/or a forward-facing surface with good coupling to wood.

In the embodiment shown in FIG. 1 the system comprises two phased arrays of ultrasonic transducers 2, 3 which are positioned or mounted at an angle to the longitudinal axis of the pole 6 as shown, to direct energy through the pole towards the lower part of the pole below the ground surface in the form of a beam 4, and to receive energy reflected back to it through the pole. Alternative configurations may comprise a single transducer or three or more transducers, spaced around the pole as will be referred to further. Alternatively again, one or more separate receiving probes may be positioned to receive reflected energy, from one or more separate transmitting probes. The transmitting and receiving probes may be positioned diametrically opposite from each other, or at different heights, and oriented at the same angle to the pole axis or at a different angle, to receive the strongest reflected signal.

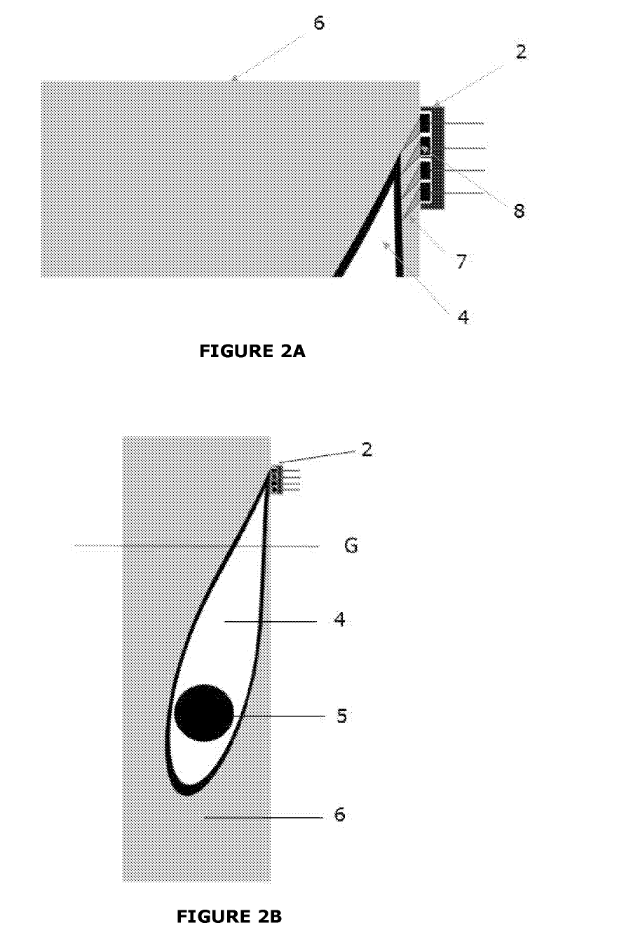

In the embodiment shown in FIG. 2A, multiple individual transducers 8 can be spaced within a phased array 2 in contact with the pole 6 to direct energy into the pole. These multiple transducers 8 can be pulsed either independently or at varying timings, for example all at once or in a sequence. The beam 4 from the phased array of transducers 2 can be focussed and swept electronically without moving the actual probe itself.

Furthermore, as shown in FIG. 1, there can be multiple arrays of transducers 2 and 3 spaced around the pole 6 which may improve the ability to identify defects. A greater number of transducers 8 in each array 2 may increase focus or resolution. Multiple arrays may be spaced equidistantly or non-equidistantly, at the same or different heights from the ground, circumferentially around the pole, and may minimise distortions for example from vertical cracks which might otherwise isolate segments of the pole from the ultrasonic energy. Multiple arrays may be arranged in other configurations, such as a spirally around the pole.

As shown in FIG. 1, phased transducer arrays 2 and 3 can be spaced any distance on the pole 6 above the surface of the substrate. Transducer arrays are ideally positioned at a sufficient height on the pole that reverberations due to cross-pole echoes can be distinguished from reflections from below ground. For example, the transducer height above ground-line may be a least one pole circumference or more than one pole circumference. The maximum distance above ground-line will be limited by signal attenuation. In some embodiments, each phased array can be spaced a different distance above the surface from the other arrays. For example, the phased arrays can be arranged to loop around the pole at increasing distance forming a spiral up the pole. A greater number of transducer arrays around the pole may increase spatial resolution and avoid distortions from vertical cracks which might otherwise isolate segments of the pole from the ultrasonic energy.

In one embodiment, the direction of the ultrasonic beam of energy may be directed with the use of a mount or mounts used to couple the phased array(s) of transducers at an angle to the pole. The angle may be from above 0 to below 180 degrees such as for example about 30 to about 60 degrees, to assess the pole below the surface to a depth of up to four metres, for example, but also enable the pole above the transducers to be examined in the same way. The angle may depend on the depth to which the pole or other element is to be assessed. The mount or mounts may hold the phased array(s) of transducers in a fixed position or may comprise for example a rotating carriage arranged to enable manual moving of the phased array(s) of transducers around the circumference of the pole, or having an associated motor drive system and controller arranged to step the phased array(s) of transducers around the circumference of the pole. A system with manual or automatic repositioning may comprise a built in digital compass to record position and a laser distance finder to record position above ground level for example. The transducer mount(s) may be adjustable to enable a range of different angles between these extremes to be used to inspect different regions of the pole by producing beams with different angles. For example, a transducer could be located at multiple different positions around the circumference of the pole and at multiple different vertical locations over a range of heights above ground, to enable most if not all of the region of interest to be probed with the ultrasonic beam(s). Another embodiment may use arrays of ultrasonic transducers that can be phased to produce beams that can sweep through the wood. However, in a simplest embodiment the mounts may comprise or include wedges between the surface of the pole and the transmitter(s), receiver(s) and/or transducer(s), which position the transmitter(s), receiver(s) and/or transducer(s) at an angle to the pole, and are acoustically coupled to the transmitter(s), receiver(s) and/or transducer(s) to the pole. A range of wedges may be provided with different angles. The material of the wedge should be selected to minimize reflection or refraction at the interface with the pole. This would typically require the wedge to be made of a material with similar acoustic properties, such as refractive index, to the wood in the pole (e.g. a fibre composite).

The acoustic coupling of the transducer(s) with the pole can be increased by using a high viscosity fluid such as a gel, or a compliant pad, which can conform to both surfaces, and which ideally has acoustic properties, such as refractive index, close to that of the wood in the pole.

Alternatively, the acoustic coupling between the transducer(s) and pole may be achieved or improved by the end(s) of the probe(s) being shaped such as pointed, to penetrate the surface of the pole. As shown in FIGS. 2A and 2B, separately shaped, such as pointed, interface elements 7, to which the transducers 8 couple, may be provided. These interface elements penetrate the surface of the pole and provide acoustic coupling to the transducers 8. The shaped, such as pointed interface elements, penetrate the surface of the pole 6 to achieve sufficient contact with good wood but without causing structural degradation or reduction in strength of the pole 6. Alternatively, the shaped such as pointed interface elements 7 may be inserted into holes in the pole. These holes might be pre-existing or made specifically to fit the interface elements.

The shaped, such as pointed interface elements 7, are designed and shaped to reduce the amount they resonate as much as possible. For example, they may be tapered and sized to reduce resonance. The material's acoustic properties, such as refractive index, should also be preferably close to wood (for example, a fibre composite may be used).

The transducer interface elements described above may be low cost and designed to be robust so that they can be removed and reused on other poles, or may be left in the pole after inspection has been completed so that such poles can be more easily inspected in the future, or as a time saving measure to simply dispose of the transducer elements. The transducer elements may also be shaped to direct energy from the transducers in order to accommodate the anisotropy of wood. In general, the speed of sound in the wood grain direction is approximately twice that across the grain. In practice the principal access of the transducer is between 0 and 45 degrees. The angle of insertion can be adjusted to assist with directing the energy towards the region of interest.

In another embodiment for example the transducer(s) or the transducer interface elements may be flat edge transducer inserts into the pole with the flat edge pointing in the direction of interest.

As shown in FIG. 1, a processor 1 is arranged to analyse the reflected energy and provide an indication of the presence of rot or decay 5 or similar in the below ground part of the pole 6. The analytics might be performed onsite or remotely or in some combination of onsite and remote analysis. For example, data could be transmitted from the probe to a local data processor via a Bluetooth link and from the local data processor to a cloud-based analytical capability via a cellular microwave link. The result may be a simple numeric scale indicative of rot or decay, but preferably the processor 1 is arranged to display a visual assessment of material below the surface of the substrate. Variations in the form of reflected energy can be interpreted in terms of the type and distance of defects from the probe. Information from a range of scans may be integrated into 2D or 3D representations of the below ground structure of the pole. This more comprehensive set of information resulting from these multiple reflections may be used to provide a more complete description of the acoustic discontinuities and aid in their interpretation. For example, the results of the individual reflections may be used to produce a tomographic map of the below ground structure of the pole. The individual reflections and the maps produced from multiple reflections would then be interpreted as various forms of typical defects such as rot, insect infestation, delamination, etc. Animations of representations of the pulse echoes and their reflections may also be used to display the results of the scan reflections. The condition of a wooden pole may be determined as a result of analyzing the results of a single beam or might require a more comprehensive analysis of multiple beams as described previously.

The information can not only provide an analysis of the residual strength of a pole (e.g. residual effective diameter) but, combined with a knowledge of the stresses that a particular pole is under due to both the static loading of transmission cables and supporting guys and dynamic loads from wind shear, may predict fitness for use. This is one example of how the digital information available from this test can be entered into a Cloud data base and be combined with other sets of data such as weather patterns, climate change, geo positioning, etc. and analytical packages such as predictive maintenance schemes, capital planning, etc. to increase its value.

The information can be used to develop a library of scan data in order to develop a body of knowledge based on different pole types, species, strength classes, lengths and known defects. This library can be used to give further insight into future results and to help give more accurate readings. Machine learning techniques may also be used for ongoing analysis of existing and previously scanned poles to fine tune the results from both current and previous pole scans.

This invention may have application for a range of structures involving the analysis of the interior structure of wood and similar materials with comparably low densities (e.g. between 0.01 to 2.5 g/cm³, such as many polymers, asphalt, some ceramics, graphite, etc.) where it is difficult to probe the region of interest. These other uses may include pilings for buildings, wharf pilings, structural timber that is encased in other materials or located in difficult to access areas, inspection of tree trunks and root systems, etc.

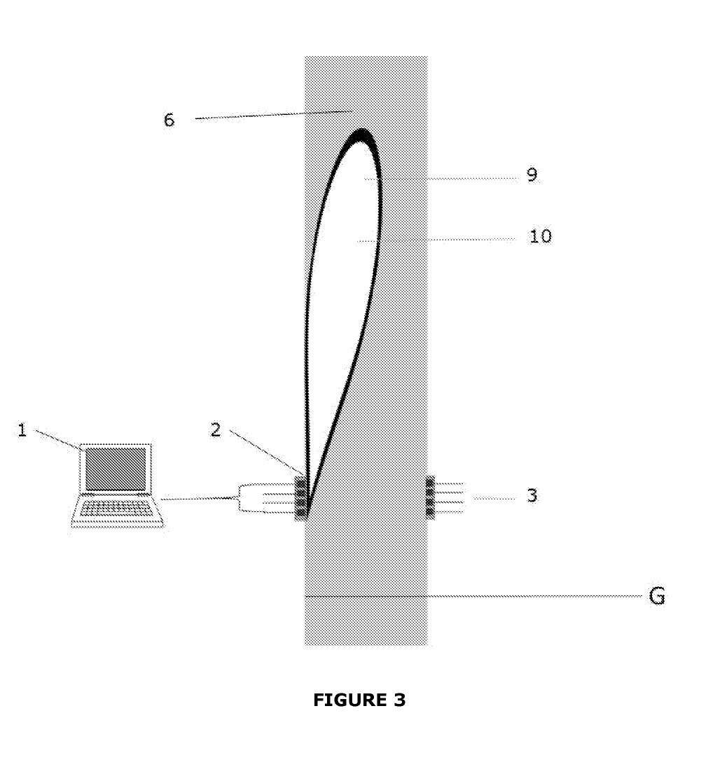

In at least some embodiments the method or system also includes calibrating the system by transmitting and receiving through the body above the surface of the substrate. FIG. 3 illustrates a calibration option. The transducer(s) or phased array(s) of transducers may be calibrated to the particular material of the pole to be examined by conducting one or more scans into parts of the pole with wood known to be free of flaws 9, such as regions of known “good wood” (no or low decay) above ground, before scanning the pole below ground for defects as illustrated in FIG. 1, and using these results as a basis of comparison with the response of wood below ground of unknown composition. Alternatively, energy transmitted and received between two or more transducers above ground may be used to calibrate the system before the transducers are used to transmit and receive below ground. In the figures line G indicates ground level or ground surface.

FIGS. 2A and 2B show two cross-sections of a pole; FIG. 2B view shows part of the pole above ground and an angled phased array transducer 2 and the buried pole end, and FIG. 2A shows an enlarged view of part of the same pole and transducer. The closer view shows the transducers 8 coupled to the pole 6 using the shaped, such as pointed interface elements 7 described above. In this instance a phased array 2 produces a beam 4 which scans across a range of angles (e.g. 0 to 90 degrees perpendicular to the surface of the wedge). In this configuration, the scanner is capable of creating a sectional scan of the bottom of this pole, which is 0.36 m in diameter and buried to a depth of 2.5 metres. The pole illustrated is a typical Class 1 pole according to ANSI 05.1 with a length of 15 metres, a diameter of 0.36 metres buried to a depth of approximately 2.5 metres. By varying the focal length and scanned angle of the beam, scans at different depths from the ground to the bottom of the pole may be produced. These scans enable distinguishing the interface between the pole and the ground and detecting discontinuities within the pole, such as rot, termite damage, delamination and cracks. Deterioration or damage of the surface of the pole, such as caused by surface rot, can also be expressed as a reduction in the apparent diameter of the pole.

FIG. 3 is similar to FIG. 1 but schematically shows a cross-section of a pole and a phased array transducer 2 scanning part of the pole above ground. The phased array of transducers is positioned and operated to direct a focussed beam of energy 10 through the pole towards the above ground part of the pole 9, and to receive energy reflected back through the pole. In FIG. 3 line G indicates ground level or ground surface. The embodiment shown in FIG. 3 can be used in the calibration steps described above, wherein the phased array of transducers 2 conduct one or more scans into parts of the pole above the ground level with wood known to be free of flaws 10. This embodiment can also be used to test for defects in the wood above the ground level, using the same method but focusing the energy of the transducers at an upward angle. This can be useful for identifying different defects than those which exist under the ground, such as woodpecker holes or pocket rot. In this embodiment when used for examining for defects above the ground the ultrasonic energy can penetrate into the pole 6 for example greater than six metres above the level of the transducer or array of transducers, and preferably detect defects with dimensions on the order of a centimetre or more.

The electronics can be programmed to produce a series of horizontally or vertically planar images of the ultrasonic echoes which will reveal the remaining side and lower boundaries of the pole and any internal discontinuities. The combination of the planar images provides a three-dimensional view of the below ground structure of the pole, which is useful for determining its fitness for use.

A specialised form of a phased array may be possible whereby two surface mounted transducers operate so as to produce a wave that transmits axially near to the surface of the pole to detect the rot on the surface of the pole, since rot would transmit ultrasonic energy differently than solid wood.

The information received for each pole can be used to identify changes in the pole over its life by comparing records of this information taken at different times during the life of the pole including prior to use.

The foregoing description of the invention includes preferred forms thereof. Modifications may be made thereto without departing from the scope of the invention as defined in the accompanying claims.

1. A system for assessment of irregularity in material below a surface of a substrate, from above the surface of the substrate, the material being part of a body of the material surrounded by the substrate below the surface of the substrate, the body extending from below to above the surface of the substrate, and the assessment system being adapted to be positioned above the surface of the substrate, the system comprising:
at least one transmitter and receiver or transducer arranged to transmit energy through the body from above the surface of the substrate towards the material of the body below the surface, and receive energy reflected from the material back through the surface, and
a processor arranged to analyse the reflected energy and provide an indication of irregularity in the material below the surface of the substrate.

2. A system according to claim 1 wherein the transmitter(s) or transducer(s) are arranged to transmit the transmitted energy in a focused beam shape and/or direction through the material of the body.

3. A system according to either claim 1 or claim 2 comprising an array of multiple transmitters and a receiver or receivers, or an array of multiple transducers.

4. A system according to claim 3 comprising two or more arrays of multiple transmitters or multiple transducers.

5. A system according to either claim 3 or claim 4 comprising at least one array which is a phased array.

6. A system according to claim 5 wherein the phased array is a dynamically phased array enabling steering of the transmitted energy through the material of the body below the surface.

7. A system according to any one of claims 1 to 6 comprising a mount or mounts adapted to position the transmitter(s) and receiver(s) or transducer(s) adjacent the body above the surface of the substrate and at an angle to an axis of the body extending from below to above the substrate.

8. A system according to claim 7 wherein the mount or mounts are adapted to enable adjustably positioning the transmitter and/or receiver or transducer at multiple different angles.

9. A system according to any one of claims 1 to 8 comprising a mount or mounts adapted to position the transmitter(s) and receiver(s) or transducer(s) at locations spaced around an axis of the body extending from below to above the substrate.

10. A system according to claim 9 wherein said locations are spaced substantially equidistantly around said axis of the body.

11. A system according to any one of claims 1 to 10 comprising a mount or mounts adapted to enable adjustably positioning the transmitter and/or receiver or transducer at multiple different vertical spacings above the surface of the substrate.

12. A system according to any one of claims 1 to 11 wherein the transmitter(s) or transducer(s) is/are arranged to transmit energy as a pulse of duration less than about 250 milliseconds or less than about 100 milliseconds or less than about 50 milliseconds or less than about 2 or 1 millisecond(s), or as a series of such pulses.

13. A system according to any one of claims 1 to 12 wherein the transmitter and receiver or transducer operate at a frequency or frequencies above about 200 Hz or above about 2 kHz or above about 5 kHz or above about 10 kHz or above about 20 kHz.

14. A system according to any one of claims 1 to 12 wherein the transmitter and receiver or transducer operate at a frequency or frequencies below about 500 kHz or below about 100 kHz or below about 100 kHz or below about 20 kHz.

15. A system according to any one of claims 1 to 12 wherein the transmitter and receiver or transducer operate at an ultrasonic frequency or frequencies.

16. A system according to any one of claims 1 to 15 wherein the transmitter(s) or transducer(s) has a Q factor of not more than about 4.

17. A system according to any one of claims 1 to 16 wherein the transmitter(s) or transducer(s) comprise(s) an interface element(s) adapted to penetrate into the surface of the substrate.

18. A system according to any one of claims 1 to 17 arranged to assess irregularity in the material below the surface of the substrate to an extent or depth of at least 0.5 metres below the surface of the substrate.

19. A system according to any one of claims 1 to 18 wherein the processor is arranged to provide to a display a visual assessment of the material below the surface of the substrate.

20. A system according to any one of claims 1 to 19 wherein the substrate is ground, and the material is wood below the ground surface, or a wooden element extending from below the ground surface to above the ground surface.

21. A system according to claim 20 wherein the processor is arranged to analyse the reflected energy for rot, decay, insect infestation or damage, holes, or delamination in the wooden element below the ground.

22. A method for assessment of irregularity in material below a surface of a substrate, from above the surface of the substrate, the material being part of a body of the material surrounded by the substrate below the surface of the substrate and the body extending from below to above the surface of the substrate, the method comprising:
directing energy from a transmitter or transducer, through the body from above the surface of the substrate, towards the material of the body below the surface, receiving energy reflected from the material back through the body, and
analysing the reflected energy to determine an indication of irregularity in the material below the surface of the substrate.

23. A method according to claim 22 comprising directing energy from the transmitter(s) or transducer(s) in a focused beam shape and/or direction through the material of the body.

24. A method according to either claim 22 or claim 23 comprising directing energy from an array of multiple transmitters and a receiver or receivers, or an array of multiple transducers.

25. A method according to claim 24 comprising directing energy from two or more arrays of multiple transmitters or multiple transducers.

26. A method according to either claim 24 or claim 25 comprising directing energy from at least one array which is a phased array.

27. A method according to claim 26 comprising directing energy from at least one dynamically phased array enabling steering of the transmitted energy through the material of the body below the surface.

28. A method according to any one of claims 22 to 27 including first calibrating the system by transmitting and receiving through the body above the surface of the substrate.

29. A system for assessment of irregularity in material below a surface of a substrate, from above the surface of the substrate, the material being part of a body of the material surrounded by the substrate below the surface of the substrate, the body extending from below to above the surface of the substrate, and the assessment system being adapted to be positioned above the surface of the substrate, the system comprising:
a transmitter and receiver or transducer, and a mount or mounts adapted to position the transmitter and receiver or transducer adjacent the body above the surface of the substrate and at an angle to an axis of the body extending from below to above the substrate, to direct energy from the transmitter or transducer through the body from above the surface of the substrate towards the material of the body below the surface, and receive energy reflected from the material back through the surface, and
a processor arranged to analyse the reflected energy and provide an indication of irregularity in the material below the surface of the substrate.

30. A system for assessment of irregularity in material, the system comprising:
at least one transmitter and receiver or transducer arranged to transmit energy in a focused beam shape and/or direction through the material of the body, from the surface of the substrate at a location of the transmitter or transducer, through the body to a location spaced along a length of the body and towards material of the body below the surface, and receive energy reflected from the material back through the surface, and
a processor arranged to analyse the reflected energy and provide an indication of irregularity in the material below the surface of the substrate.

31. A system according to claim 30 comprising an array or arrays of multiple transmitters and a receiver or receivers, or an array of multiple transducers.
